(19) United States
(12) Patent Application Publication
(10) Pub. No.: US 2006/0294083 A1
(43) Pub. Date: Dec. 28, 2006

(54) Search engine SMS notification system and method

(75) Inventors: Randall S. Benton, Tigard, OR (US); Shirley L. McMenamin/Benton, Tigard, OR (US)

Correspondence Address: OSTROLENK FABER GERB & SOFFEN, 1180 AVENUE OF THE AMERICAS, NEW YORK, NY, 100368403, US

(73) Assignee: Submitnet, Inc.

(21) Appl. No.: 11/476,958

(22) Filed: Jun. 28, 2006

Related U.S. Application Data
(60) Provisional application No. 60/694,752, filed on Jun. 28, 2005.

(51) Int. Cl. G06F 17/30

(52) U.S. Cl. 707/3

(57) ABSTRACT

The invention regards a system and method for affecting a position in a search engine ranking of a web site as a function of a messaging device. In one embodiment, the invention comprises receiving electronic search engine information by an information processor from a search engine over a communication network, wherein the search engine information regards a web site. Further, the electronic search engine information is stored in a search engine information database accessible to the information processor. Moreover, the search engine information is processed from a first format to a second format to provide processed search engine information, and the processed search engine information is provided to the messaging device over the network. Additionally, an instruction in response to the processed search information from the messaging device is received, and executed by the information processor to affect the position in the search engine ranking of the web site.

### CROSS-REFERENCE TO RELATED APPLICATIONS

The present application is based on and claims priority to U.S. Provisional Patent Application Ser. No. 60/694,752, filed on Jun. 28, 2005 and entitled “SEARCH ENGINE SMS NOTIFICATION SYSTEM AND METHOD,” the entire contents of which are incorporated by reference as if set forth fully herein. This patent application further incorporates by reference U.S. patent application Ser. No. 11/096,844, filed on Apr. 1, 2005 and entitled “SEARCH ENGINE DESKTOP APPLICATION TOOL” and European Patent Application Serial No. 60 006 692.5, entitled “SEARCH ENGINE DESKTOP APPLICATION TOOL.”

### BACKGROUND OF THE INVENTION

1. Field of the Invention

The present invention relates to Internet search engine listings, and, more particularly, to providing information regarding Internet search engine listings via short messaging services.

2. Description of the Related Art

Locating content stored on computer systems connected to the Internet remains a daunting task. Currently, over eight billion web pages are estimated to be published over the Internet. As the number of web pages grows, so does the number of pages indexed by search engines. According to various research firms like JUPITER RESEARCH, over eighty percent of online users use search engines to locate content stored on web sites. According to STATISTICAL RESEARCH, INC., fifty seven percent of Internet users use search engines to search the Internet every day, making on-line searching the second most popular Internet activity (after e-mail). Further, search engine listings outscore banner and title ads by more than two to one on measures including awareness, likelihood to click-on, and overall opinion, in a recent survey by NPD GROUP. The survey also concludes that consumers are five times more likely to purchase products from web sites discovered in a search than by selecting web site banner advertisements. Thus, listing web sites with search engines remains a critical way for proprietors of web sites to ensure a successful implementation. The ability to be listed in search results and ranked at or near the top of a list is believed to be no accident; careful planning and execution are required for a web site to be effectively listed.

A typical search engine functions to maintain a database of web sites that is referenced whenever a search request is submitted by a user. For example, after a person establishes a communication session with the search engine (i.e., “visits” the search engine), the person submits search terms (also referred to herein as “key terms”) in a graphical screen control, such as a textbox, and the database is queried to retrieve listings that correspond to the key term(s). The listings typically include hyperlinks to the web sites in the list, and by selecting one of the hyperlinks, the user is directed to the corresponding web site.

Thus, people use prior art search engine technology to sift through billions of Internet web pages in order to locate content that may be provided on only a small fraction thereof.

In a typical case, an Internet web site comprises a collection of electronic files, including, for example, documents, images, sound files and programming code, referred to herein as web site “pages” which provide content via the hypertext mark up language (“HTML”). One web site page in particular, the so-called “home page” of a web site, typically includes hyperlinks to related web site pages that are often stored in file directories relative to the home page. For example, the home page, www.tools.com links to a page illustrating power drills out the location, www.tools.com/powertools/drills.htm. The pages that are linked to the home page often include hyperlinks back to the home page, thereby connecting a series of web site pages to provide the web site.

Currently, there are relatively few varieties of prior art search engines available on the Internet. One kind, the so-called crawler-based engine, automatically visits Internet web sites and stores information in a database regarding the web sites visited. For example, the engine visits an Internet web site, and “spider” software electronically “crawls” through web site pages that are linked to the web site home page, for example, by automatically selecting hyperlinks on the home page. By “crawling” through related web site pages, updates and changes made to various web sites pages are discovered and the database is maintained with relatively current information.

Another kind of search engine, sometimes referred to as a “human-powered” search engine, includes a database of Internet web sites that is maintained by people who make web site-related entries in the database. Human-powered search engines are believed to offer an advantage over crawler-based engines because web sites are actually reviewed by a person who is then able to categorize the web sites accurately. When a user makes a search for content, for example, via a key term search, the search results retrieved by the human-powered search engine are presumably more accurate and useful than search results provided by a crawler-based engine, described above. Unfortunately, and unlike crawler-based engines, however, maintaining human-powered search engines is very time consuming and can preclude making frequent updates to the database to remove obsolete information.

A third kind of prior art search engine comprises a hybrid of human-powered functionality and crawler-based functionality. For example, spider software discovers a web site and makes an entry in a database. However, the spider may not categorize or index the entry automatically. Instead, a human reviews the web site (or a representation thereof, such as a JPEG image file of the web site) and categorizes the site accordingly. Thus, the features of both kinds of prior art search engines are synthesized into a sort of hybrid model that utilizes the benefits of each.

Over time, search engines have provided sophisticated services. For example, many well-known search engines, such as www.google.com, www.yahoo.com, www.findwhat.com or the like, employ various business models which increase a web site's chances that it will be listed in response to a search request submitted by a user. In one prior art scenario, a search engine collects bids from web sites that compete to be listed by the search engine. A proprietor of a first web site who wishes to be listed by a search engine in response to a key term search submits a monetary (e.g., $5.00) bid with the search engine. Proprietors of competing web sites also submits bids and the bids are submitted whenever a user searches for web site related to a key term term, such as the term, “information.” The web site proprietors bid to be ranked in a favorable position at or near the top of a list of web sites provided by the search engine. Accordingly, the competing proprietors may bid higher amounts (e.g., $7.50) in order to be better ranked or listed in response to the key term search. Typically, the highest bidders are listed with the best ranking.

Search engines employ another business model, referred to in the industry as the pay-per-click or cost-per-click (“CPC”) model. In this model, search engines generate revenue by charging a small fee (e.g., 25¢) when any Internet web site is listed by the search engine in response to a key term search and the searcher selects the hyperlink to the web site in the list. Accordingly, a proprietor of a web site pays the search engine fee when a user of the search engine selects a hyperlink to the proprietor's web site from the search engine listing.

In the prior art, a proprietor of web site submits descriptive information regarding his web site to a search engine. The search engine stores the information in a database and uses it to list the web site in response to a search for content. Search engines, on average, receive thousands of submissions every day, so it may be two to three months before a web site is actually listed by a search engine. Further, there is no guarantee that a web site will be prominently ranked. It is believed by the inventor that in order to be effectively listed, proprietors of web sites should make several submissions during the course of a year to each of a plurality of search engines to ensure the search engine maintains current and accurate information, and that the web site can be discovered by users seeking content over the Internet.

Proprietors of Internet web sites use various known techniques to customize Internet web pages in order to increase the likelihood of being listed by a search engine. For example, proprietors strategically place content on a web page, add meta tags, textual descriptions of images (e.g., via the ALT tag) and various information content that is relevant to the tags, images and subject matter of the site. Such activity optimizes web sites to be effectively represented by search engines. For example, search engines reference the web page title, description and various HTML tags to gather web site information. The description tag provides the engine with a synopsis of a web site. The key terms tag provides terms for a search engine to associate with the web site. Furthermore, search engines often assign greater value and importance to the text located at the top of a page than to the text located in the middle or at the bottom of a page. Thus, the position of content in a web site page can affect the ranking of the site by a search engine.

Search engines use information in meta tags in conjunction with the information content in the web page (i.e., the HTML body) to calculate measurements of key term ratios. A high ratio of key terms present in meta tags to key terms present in the HTML body is believed to improve the ranking of the web site by a search engine with respect to those key terms. For example, a web site that offers gift baskets as a product offering but uses key terms in their content and meta tags like “presents,” “Christmas,” “holidays,” “discounts,” “teddy bears,” etc. will have a difficult time obtaining good quality ranking because the use of “gifts,” “baskets,” “gift baskets,” etc. does not effectively represent the product offering.

In the prior art, proprietors of Internet web sites are typically notified of their web sites' placement and performance in search engines via e-mail correspondence. For example, search engine optimization (“SEO”) information and search engine marketing (“SEM”) information, including communication with proprietors regarding the proprietors' web site design and paid search accounts, is typically provided via e-mail. SEO information regards the degree in which a web site is optimized to comply with search engine technology and be well-ranked by a search engine. SEM information regards the degree in which a web site is introduced and submitted to a search engine. Typically, after e-mail notifications are received from a search engine, proprietors “log in” via a search engine user interface and receive electronic reports regarding web site listings and how web site marketing campaigns are performing.

Referring now to the drawing figures in which like reference numerals refer to like elements, there is shown in FIG. 1 a prior art arrangement of devices communicating over a communication network. As shown in FIG. 1, Internet web site servers 102 provide content that is available for user terminal 104. Internet web site 102 preferably are listed by search engines 106 in order for user terminals 104 to locate the content provided on Internet web site servers 102. Search engines 106 preferably provide uniform resource locator (“URL”) listings in response to key word or other kinds of searches provided by users. As used herein, reference to a listing of web sites by a search engine, or similar usage, refers, generally, to providing one or more hyperlinks, including a uniform resource locator, to an Internet web site server 102. Of course, one skilled in the art will recognize that search engine 106 may operate as Internet web site server 102 and be listed by other search engines 106. In an embodiment, devices 102, 104 and 106 communicate using the hypertext transfer protocol (“HTTP”) over communication network 108, such as the Internet. Communication pathways 110 preferably include packets of information transmitted between the respective devices.

FIG. 2 shows a prior art arrangement of parties operating or managing the devices displayed in FIG. 1. As shown in FIG. 2, proprietor of web site 202 communicates over communication network 108 to provide content.

As used herein, a “proprietor of a web site” or “proprietor” refers, generally, to an owner of an Internet web site, a person authorized with directing or exercising control over any appearance, content and/or features provided in a web site, a person authorized to post content on the web site, or any party acting on behalf thereof. Thus, as used herein, a proprietor can include any party acting in an agent or representative capacity for one who is authorized to control a web site. As one skilled in the art will recognize, a proprietor does not have to be in physical proximity with the device in order to exercise control over it.

Search engine provider 204 operates a search engine for listing Internet web site servers 102 in response to key word or other types of searches from users 206. Search engine provider 204 may offer various business models for proprietor 202. For example, search engine provider 204 establishes an account for proprietor 202 for a pay-per-click or auction type business arrangement (described in greater detail below). Alternatively or in addition, search engine provider 204 receives information regarding web site server 102 and stores the information in a database to list web sites provided by servers 102 in response to a search by user 206. As noted above with respect to FIG. 1, transmission lines 110 include packets of information that are transmitted between the various parties and over communication network 108.

It is believed that prior art methods which proprietors of web sites use to submit information to and communicate with search engines is very cumbersome and time consuming. For example, proprietors of web sites who are trying to maximize placement on a listing provided by search engines through paid and non-paid (so called “organic” or “natural”) search engine placement require information and feedback regarding their web site listings. Typically, information provided by a search engine to a proprietor via e-mail is very minimal and the proprietor invests additional time and effort in order to log in to search engines and research search engine information issues to a greater degree.

Thus, effective search engine placement listing is necessary for a web site to be prominently represented, and, accordingly, found by Internet users. Unfortunately, information regarding search engine performance and the frequency and quality of search engine ranking is difficult to obtain in the prior art, making it increasingly difficult for a proprietor of a web site to ensure that his web site is well represented and prominently listed by a plurality of search engines.

### SUMMARY OF THE INVENTION

The preset invention solves the above-described problems associated with prior art search engines, and provides a robust software application that connects proprietors of web sites via short messaging services, and search engines in order to provide a regular, informative and secure flow of communication therebetween.

In a preferred embodiment of the present invention, information pertaining to search engine optimization and search engine paid inclusion is transmitted to a proprietor of a web site via text or multimedia messages sent to the proprietor's messaging device(s).

The invention regards a system and method for affecting a position in a search engine ranking of a web site as a function of a messaging device. In one embodiment, the invention comprises receiving electronic search engine information by an information processor from a search engine over a communication network, wherein the search engine information regards a web site. Further, the electronic search engine information is stored in a search engine information database accessible to the information processor. Moreover, the search engine information is processed from a first format to a second format to provide processed search engine information, and the processed search engine information is provided to the messaging device over the network. Additionally, an instruction in response to the processed search information from the messaging device is received, and executed by the information processor to affect the position in the search engine ranking of the web site.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates prior art arrangement of parties and devices communicating over a communication network;

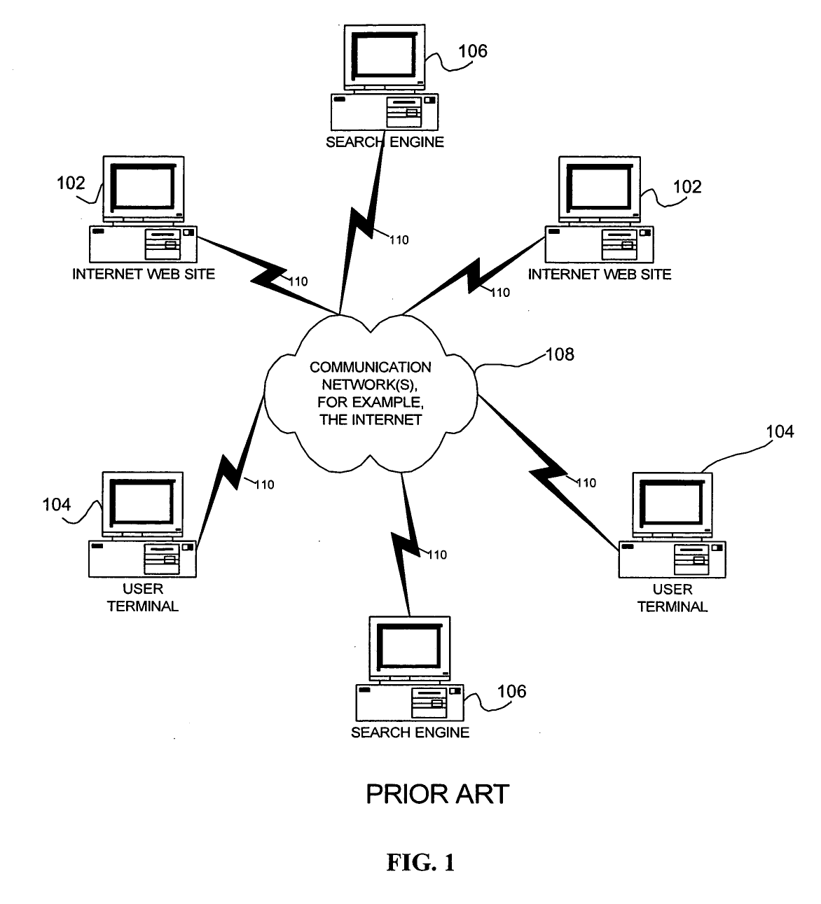

FIG. 2 shows a prior art arrangement of parties operating or managing the devices displayed in FIG. 1;

FIG. 3 illustrates an example arrangement of devices in accordance with an embodiment of the present invention;

FIG. 4 shows an arrangement of parties operating or managing the devices in accord for an embodiment of the present invention;

FIG. 5 illustrates functional elements of an information processor;

FIG. 6 illustrates an arrangement of devices in accordance with a preferred embodiment of the present invention; and

FIG. 7 shows a flow chart that illustrates steps associated with a preferred embodiment of the present invention.

### DETAILED DESCRIPTION OF EMBODIMENTS OF THE INVENTION

In one embodiment of the present invention, information pertaining to search engine optimization and search engine paid inclusion is transmitted to a proprietor of a web site via a web-based communication service that includes a software application installed on local computer system and a remote server computer. The information is preferably forwarded in its original or a modified form to an end user via short message service (“SMS”). Short message service refers, generally, to transmitting short messages, including text messages, between various devices, for example, telephones, mobile and cellular telephones, personal digital assistant (“PDA”) devices (e.g., devices operating the PALM or POCKET PC operating systems), pagers, and even personal computers.

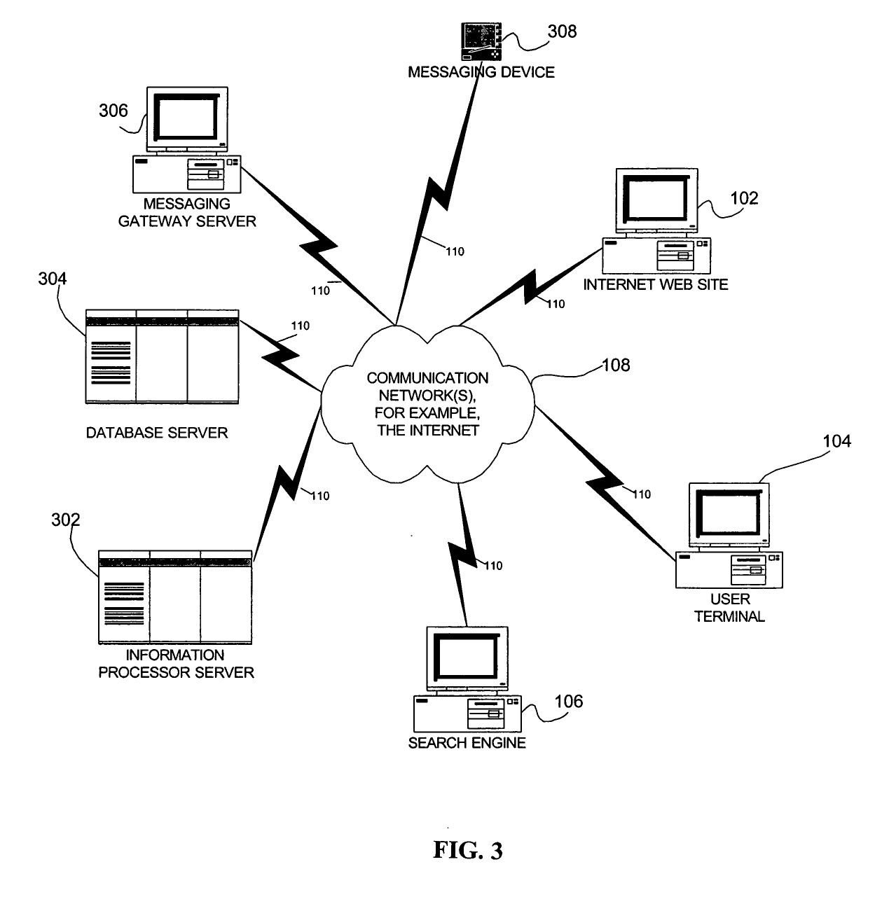

FIG. 3 illustrates an example arrangement of devices in accordance with an embodiment of the present invention and referred herein, generally, as system 100. As shown in FIG. 3, Internet web site server 102, user terminal 104, search engine 106 are represented. In addition, information processor server 302, database server 304, messaging gateway server 306 and messaging device 308 are represented. Messaging gateway server 306 is preferably a computing device that is configured to provide messaging services, such as instant messaging or other short message services.

Further, information processor 302 preferably is preferably configured to interface with search engine 106 Internet to receive information regarding web site server 102, and to relay the information to database server 304 and, thereafter, to messaging device 308 either directly or via gateway messaging server 306. Functionality provided by information processor server 302, database server 304, messaging server 306 and messaging device 308 is provided in greater detail below.

Although in the embodiment shown in FIG. 3 information processor server 302 and database server 304 is illustrated as separate devices, the invention is not so limited. One skilled in the art will recognize that one computing device, such as a computer configured to operate as a server computer, can function as information processor 302 and database server 304. In one embodiment, information processor 302 and database server 304 monitor a web site to ensure that the web site is available on the internet or is otherwise “on-line.”

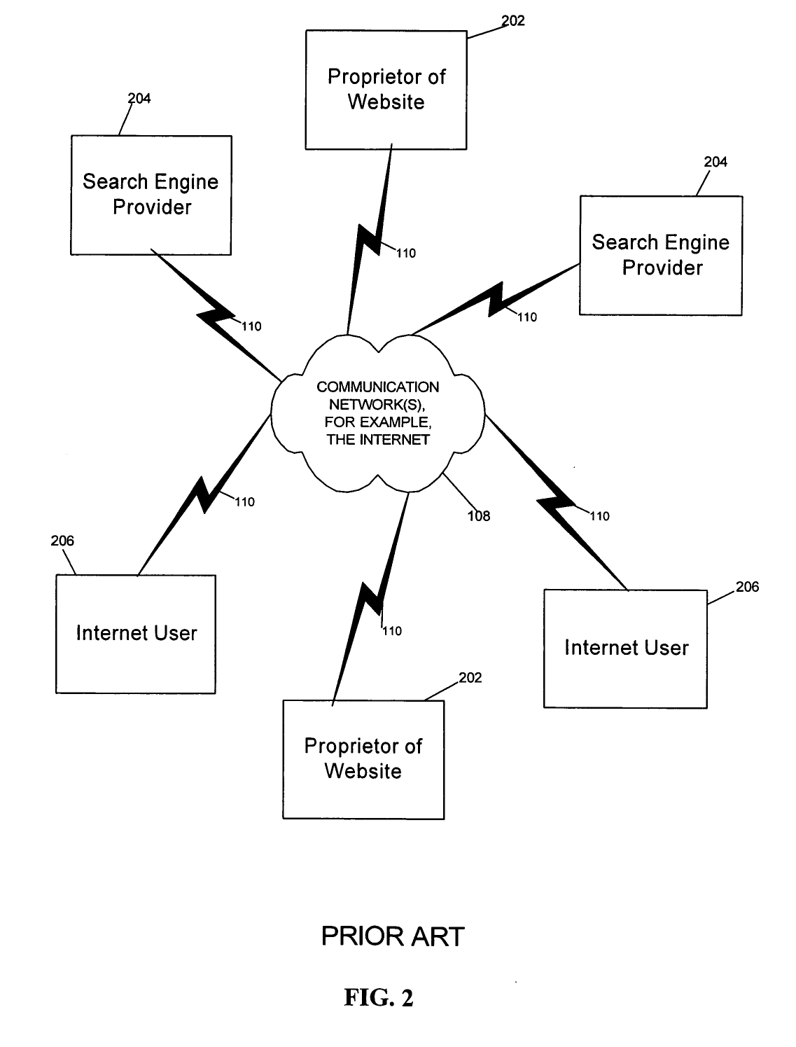

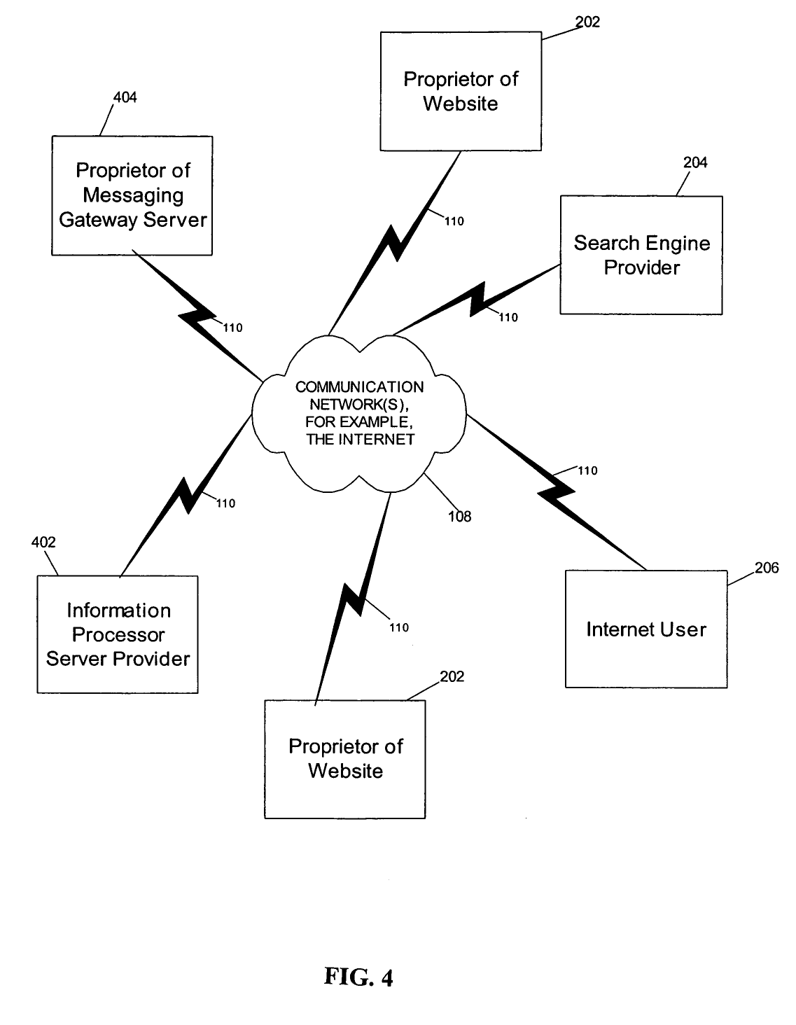

FIG. 4 shows an arrangement of parties operating or managing the devices in accordance with a preferred embodiment of the present invention. The parties illustrated in FIG. 4 are the same as illustrated in FIG. 2, with the addition of information processor server/database server provider 402 and proprietor of messaging gateway server 404. The information processor server/database server provider 402 manages and/or operates information processor server 302 in order to provide many of the services described herein. In an embodiment present invention, information processor server/database server provider 402 establishes business relationships with proprietor 202 and search engine provider 204. For example, after proprietor 202 submits information to information processor server/database server provider 402 regarding a respective internet web site server 102, information processor server provider 402 preferably establishes a relationship with a search engine to make submissions, and/or to create and/or manage accounts on behalf of proprietor 202 and search engine provider 204.

Preferably, information processor server provider 402 functions as a sort of intermediary between proprietors 202 and search engine providers 204. Information processor server provider 402 preferably establishes accounts for proprietors 202. Payment is received from proprietors 202 by server provider 402, and used to make payments into accounts held by search engines 106. Thus, for example, when a proprietor 202 wishes to increase a bid for placement, he notifies information processor server provider 402, and provider 402 uses a portion of the capital in the proprietor's account to pay search engine 106. Preferably, information processor server provider 402 charges a fee to proprietor 202 for services provided provider 402.

Information processor 302 transmits a query to search engine 106 for information regarding a web site 102. Search engine 106 preferably replies to the query by transmitting information regarding, for example, the respective ranking and placement of the web site on the search engine site. The information is relayed from information processor 302 to

In an embodiment of the present invention, proprietor 202 is given access to information processor server 302 as well as database server 304. Database server 304 preferably stores account information, such as user name and password for authorized access to servers 302/304. Once this basic information is provided, database server 304 receives information from information processor server 302, such as regarding proprietor's 202 accounts with various search engines. Once the available information has been transmitted from information processor server 302, proprietor 202 has access to information, typically formatted as reports, substantially as described below. Preferably, each report relates to a single URL and proprietor 202 selects a specific URL for analysis. Database server 304 preferably includes a process, such as a daemon (as known in the art) to determine whenever information is received, for example, from information processor 302. When database server 304 receives information from information processor server 302, a message is preferably transmitted to messaging device 308, either via messaging gateway server 306 or directly. In this way, users of messaging device 308 are alerted when new information becomes available or alerts are provided.

For example, a proprietor 202 may decide to place a bid with search engine provider 204 for the key word, “submit.” The proprietor 202 informs information processor server provider 402 that he is willing to bid two dollars for a favorable ranking by search engine 106. In one embodiment of the present invention, a financial account is established by the information processor server provider 402 on behalf of proprietor 202 and payments to search engine provider 204 are made by the information processor server provider. Information is electronically transmitted to processor 102 to alert proprietor 202, e.g., on messaging device 308, that proprietor's 202 web site has dropped in rank on the search engine. Thereafter, proprietor 202 may elect to increase the amount of his bid to increase the likelihood of a more favorable ranking. Accordingly, proprietor 202 transmits electronic payment to information processor server provider 402 and information processor server provider 402 pays search engine provider 204.

In a preferred embodiment, information processor server provider 402 enables communication to be established between proprietor 202 and search engine provider 204 via the messaging device 308. For example, the database server 304 operates to receive information and alert proprietor 202 via messaging device 308 of a change, for example, in the ranking of a web site on a search engine. Preferably, proprietor 202 submits commands to information processor server provider 402 that may effect the web site ranking. For example, the proprietor 202 responds to a prompt on his messaging device 308 to increase the amount of his bid for a keyword. Alternatively, the proprietor 202 issues a command to maintain a current bid amount, or to lower a bid amount. In one embodiment, one or more prompts are transmitted to messaging device 308 and, by responding to the prompts, proprietor 202 issues commands. Alternatively, proprietor 202 submits SMS commands to server 303 and/or 304 that represent instructions regarding web site ranking, without responding to one or more prompts. Thus, the present invention preferably establishes a communication session (i.e. directs the proprietor's 202 internet application software) to search engine provider 204 to effect the commands via messaging device 308.

Thus, the present invention preferably enables the parties to electronically maintain business relationships such as by providing a convenient and efficient transfer of capital and information to improve search engine ranking and listings via messaging device 308.

For example, the present invention notifies proprietor 202 via messaging device 308 that proprietor 202 has been out-bid on a search engine for the keyword, “scuba,” by a competitor. Proprietor 202 uses messaging device 308 to communicate electronically with server 302 and/or 304 and change the bid amount. For example, proprietor 202 submits keywords, such as “Change Account Information” and communicates via SMS with server 302 and/304 to change the respective bid. The above is an example of many different changes that a proprietor 202 can effect via messaging device 308.

In an embodiment, database server 304 provides alerts and various data reports to proprietor 102, either on-demand or at various scheduled times, via messaging device 308. For example, proprietor 202 requests near real time access to a central web server without having submit to a user name and password, or otherwise “log in.” In an embodiment, database server 304 recognizes (e.g., via a daemon) that an alert has been received, and notifies proprietor 202 via messaging device 308 (either directly or via messaging gateway 306) of various aspects of his/her account (either, for example, with information processor server/database server provider 402 or search engine provider 204). Various events that may indicate an alert include, for example, new SEO and PI reports being made available by information processor server 302, account renewal information, change in the uptime of proprietor's 202 web site (i.e., web site 102 becomes unavailable), and the creation of custom notifications by information processor server provider 402. In one embodiment, database server 304 makes a request to an XML gateway (described in greater detail below), to check for new alerts at set intervals. The intervals are preferably defined such that various kinds data that may become obsolete is updated on a more frequent basis than data that are less likely to change.

Information processor 302 and/or database server 304 preferably includes all databases necessary to support the present invention. However, it is contemplated that information processor 302 and/or database server 304 can access any required database via communication network 108 or any other communication network to which information processor 302 may be coupled. Communication network 108 is preferably a global public communication network such as the Internet, but can also be a wide area network (WAN), local area network (LAN), or other network that enables two or more computers to communicate with each other.

In an embodiment, information processor 302, database server 304, messaging gateway server 306 and/or user terminals 104 are any devices that are capable of sending and receiving data across communication network 108, e.g., mainframe computers, mini computers, personal computers, laptop computers, a personal digital assistants (PDA) and Internet access devices such as Web TV. In addition, information processor server 302, database server 304 and/or user terminals 104 are preferably equipped with a web browser, such as MICROSOFT INTERNET EXPLORER, NETSCAPE NAVIGATOR, MOZILLA FIREFOX or the like. Information processors 302 and user terminals 104 are coupled to communication network 108 using any known data communication networking technology.

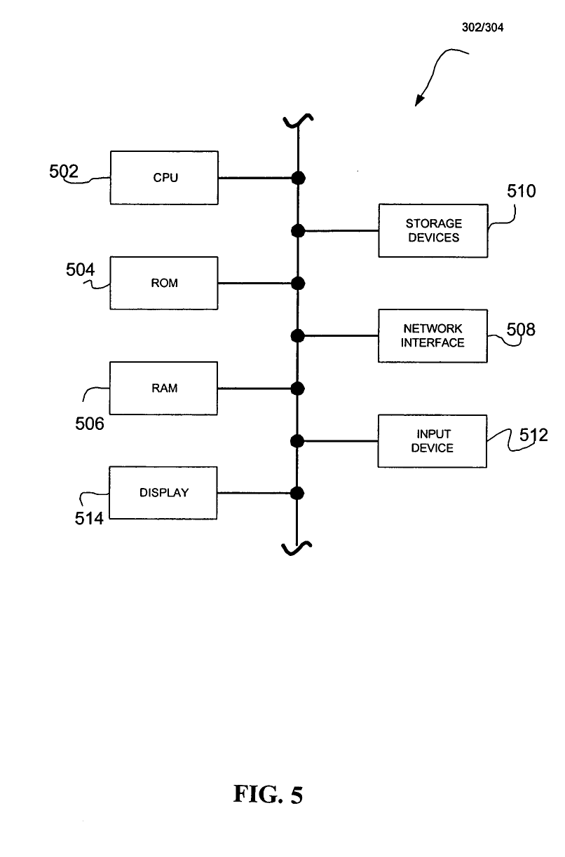

As shown in FIG. 5, the functional elements of each information processor 302 and/or database server 304 are shown, and include one or more central processing units (CPU) 502 used to execute software code and control the operation of information processor 302, read-only memory (ROM) 504, random access memory (RAM) 506, one or more network interfaces 508 to transmit and receive data to and from other computing devices across a communication network, storage devices 510 such as a hard disk drive, floppy disk drive, tape drive, CD ROM or DVD for storing program code databases and application data, one or more input devices 512 such as a keyboard, mouse, track ball, microphone and the like, and a display 514.

The various components of information processor 302/database server 304 need not be physically contained within the same chassis or even located in a single location. For example, storage device 510 may be located at a site which is remote from the remaining elements of information processor 302, and may even be connected to CPU 502 across communication network 108 via network interface 508. Information processor 302/database server 304 preferably includes a memory equipped with sufficient storage to provide the necessary databases, forums, and other community services as well as acting as a web server for communicating hypertext markup language (HTML), Java applets, Active-X control programs or the like to user terminals 104. Information processors 302 are arranged with components, for example, those shown in FIG. 5, suitable for the expected operating environment of information processor 302. The CPU(s) 502, network interface(s) 508 and memory and storage devices are selected to ensure that capacities are arranged to accommodate expected demand.

As used throughout herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of information processor 302/database server 304, shown in FIG. 5, are of the same categories of functional elements present in user terminals 104. However, not all elements need be present in the user terminals 104. For example, storage devices, in the case of PDA's, and the capacities of the various elements are arranged to accommodate the expected user demand. For example, CPU 502 in user terminal 104 may be a smaller capacity CPU than the CPU present in information processor 302. Similarly, it is likely that the information processor 302 will include storage devices of a much higher capacity than storage devices present in user terminals 104. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., information processor 302), system 100 is not limited to such a configuration. It is contemplated that system 100 is arranged such that user terminal 104 communicates with and displays data received from information processor 302 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 302 and user terminal 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on information processor 302/database server 304 and user terminal 104 regard the process of communicating data across communication network 108 and processing the data such that the data are viewed on a display 514, for example by using a web browser and the like. As is common with web browsing software, the display 514 on user terminal 104 presents sites within the system 100 such that a user can proceed from site to site within the system by selecting a desired link.

Therefore, each user's experience with system 100 is based on the order with which he/she progresses through the display screens. Graphic controls are preferably available in the display screens and modules to initiate data processes, and to provide convenient navigation between the display screens and modules of system 100. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 100.

The following is a brief description of at least a partial implementation of an embodiment of the present invention. Although the following contains particular details with respect to implementing the present invention, one skilled in the art will recognize that various architectures are available to implement the present invention across communication network 108. Therefore, the following description is illustrative to teach one skilled in the art how to build an embodiment of the invention, and is not intended to limit or restrict the invention to any one particular implementation or technology.

In an embodiment of the present invention, data are transmitted to database server 304 via an XML gateway that resides on information processor server 302. Database server 304 preferably recognizes when data from the XML gateway are received from server 302. Preferably, database server 304 performs a query on a database to form an appropriate short message to be transmitted to messaging device 308. The database query preferably returns a result representing the particular messaging device 308 to transmit to, and a preferred format for the message, if any. Thus, database server 304 preferably submits messages to messaging device 308 representing position tracking and submission information regarding a respective search engine 106.

The present invention is now further described by way of an example.

A hand-crafted jewelry retailer has developed an e-commerce Internet web sites to sell his jewelry on the Internet. The retailer understands that in order to draw traffic to his Internet site, he must list the site with at least one Internet search engine. The retailer is unsure of the most effective way to list his web site with search engines and, accordingly, visits a web site provided by information processor server provider 402.

After reviewing the description of services and tools offered by the information processor server provider 402, the retailer selects a program that provides submission option features including position check features, position tracking, keyword analysis, meta tag analysis, meta tag generation, competitor analysis, link tracking, keyword spider analysis, server up time checking, HTML analysis, load time analysis, browser compatibility checking and link checking. The retailer submits a fee, for example, by providing valid credit card information to provider 402 and identifies his messaging device 308 information for receiving short messages from database server 308.

In accordance with the present invention, the retailer submits the information to information processor server 302 regarding the retailer's business. The present invention preferably provides short messages to the retailer's messaging device 308 to report on ranking and listing information by search engines.

After several weeks of reviewing information provided by database server 308 and/or information processor server 302, the retailer decides that he wishes to bid on certain key terms in a search engine in order to improve his ranking and position. Thus, the retailer establishes a connection with information processor server 302 and submits information regarding the keyword term he wishes to bid on, and the amount of money he wishes to bid. In an embodiment of the present invention, an account is maintained by information processor server provider 402 and funds in the account are used to provide bids with the search engine. Of course, one skilled in the art will recognize that alternative embodiments are foreseen. For example, as the retailer can communicate directly with search engine 106 and submit information and/or bids directly thereto. Alternatively, the retailer establishes a communication session with information processor server 302 and is directed to one or more search engines identified by the retailer for submitting information and/or bids.

After the bid has been received by the search engine, the retailer realizes an improvement in the placement and ranking of his web site by the search engine. Over time, however, the proprietor is out-bid by a competitor and, accordingly, is alerted on his messaging device 308 by the present invention thereof.

Using the features and tools of the present invention, retailers, and other businesses, organizations and individuals can realize improvement in search engine listing, placement and ranking. In addition to analyzing keywords, descriptions or other tags of the web site 102, the present invention also retrieves information regarding submissions to respective search engines, such as whether bids have been placed for key terms, or whether a pay per click arrangement has been established between the proprietor 202 and the search engine provider 204. Ultimately, improved traffic is generated and the web site(s) are more successful.

Thus, the present invention delivers search engine-related information, including organic search, paid inclusion search, bid for placement search, and web site optimization information to proprietors of web sites via messaging device 308 in order to offer proprietors a way to monitor aspects of promoting their web sites with search engines. More particularly, the present invention preferably informs proprietors of key terms that are associated with the proprietors' web sites in search engines. Further, the present invention informs proprietors of the respective position in a search results list that the proprietors' web sites for each key term associated the proprietors' web sites. Also, the present invention preferably informs proprietors of the daily, weekly, and monthly number of web site visitors who have selected a hyperlink to the proprietor's page; i.e., the number of impressions, from a list of search results. The present invention preferably informs proprietors of the number of impressions each key term has received on a daily, weekly, and monthly basis.

Preferably, the present invention relates to Internet search engine listings, and, more particularly, to a module that electronically interfaces with a centrally located database to send and receive text or multimedia message alerts to mobile devices, such as cell phones, pagers, and two-way messaging pagers; regarding Internet search engine listings.

As noted above, effective search engine placement listing is necessary for a web site to be prominently represented, and, accordingly, found by Internet users. Unfortunately, information regarding search engine performance and the frequency and quality of search engine ranking is difficult to obtain in the prior art, making it increasingly difficult for a proprietor of a web site to ensure that his web site is well represented and prominently listed by a plurality of search engines.

The present invention solves the problems associated with prior art search engines, and preferably provides a mobile device alert system that keeps proprietors of web sites informed about Internet search engine listings and/or rankings.

In an alternative embodiment of the present invention, a module is configured to operate and/or remain active on an Internet web site server 102. The module preferably monitors the status of multiple users' Internet search engine listings. The software application preferably generates text or multimedia messages and automatically sends the messages to users' mobile devices. The software application preferably also monitors the status of incoming text or multimedia message replies, and performs actions based on the content of the replies.

The present invention is preferably deployed in the search engine optimization (“SEO”) information and search engine marketing (“SEM”) information and Search Engine markets, and enables proprietors 202 to have a much higher form of control over respective ranking in a search engine listing than was previously available in the prior art. Further, the proprietor's 202 involvement with day to day monitoring of search engine 106 accounts is improved, while the amount of time previously required to monitor the account is reduced. For example, web site proprietor 202 needs only to spend time on the account when there is an issue or an indication that an alteration or change to an account is warranted. In accordance with the present invention, proprietor 202 no longer, as in the prior art, needs to spend time going back to each particular search engine 106 with which the web site provided by internet web site server 102 is associated, logging in to a respective search engine 106, and, thereafter, determining how well the web site associated with server 102 is performing. Instead, and in accordance with the present invention, information is electronically transmitted from search engine 106 to a server computer system, and the server computer's software transmits information to proprietors 202 via text or multimedia messages to the proprietors' mobile devices. Also in accordance with the present invention, the proprietor may choose to respond to the text or multimedia messages with predefined commands. The server computer system's software processes the incoming replies and performs actions relating to the proprietor's account based on the command received.

Thus, the present invention delivers search engine-related information, including organic search, paid inclusion search, bid for placement search, and web site optimization information to proprietors 202 in order to offer an improved way to monitor aspects of promoting web sites via search engines 106. More particularly, the present invention preferably informs proprietors 202 of low fund balances in paid inclusion search accounts and bid for placement accounts. Further, the present invention preferably informs proprietors of reduced ranking in search results, search engine listings that are no longer visible to search engine users, and any other alerts the proprietor asks to be notified about.

In accordance with another aspect, the present invention preferably processes text or multimedia message replies and performs actions related to the proprietor's search engine account. Actions the present invention preferably performs include adding finds to a paid inclusion or bid for placement account, changing bids on a bid for placement account, taking listings offline, putting listings back online, and requesting statistics.

Other features and advantages of the present invention will become apparent from the following description of the invention which refers to the accompanying drawings.

In one embodiment of the present invention, information pertaining to search engine optimization and search engine paid inclusion is transmitted to a proprietor of a web site via text or multimedia messages sent to the proprietor's mobile device(s).

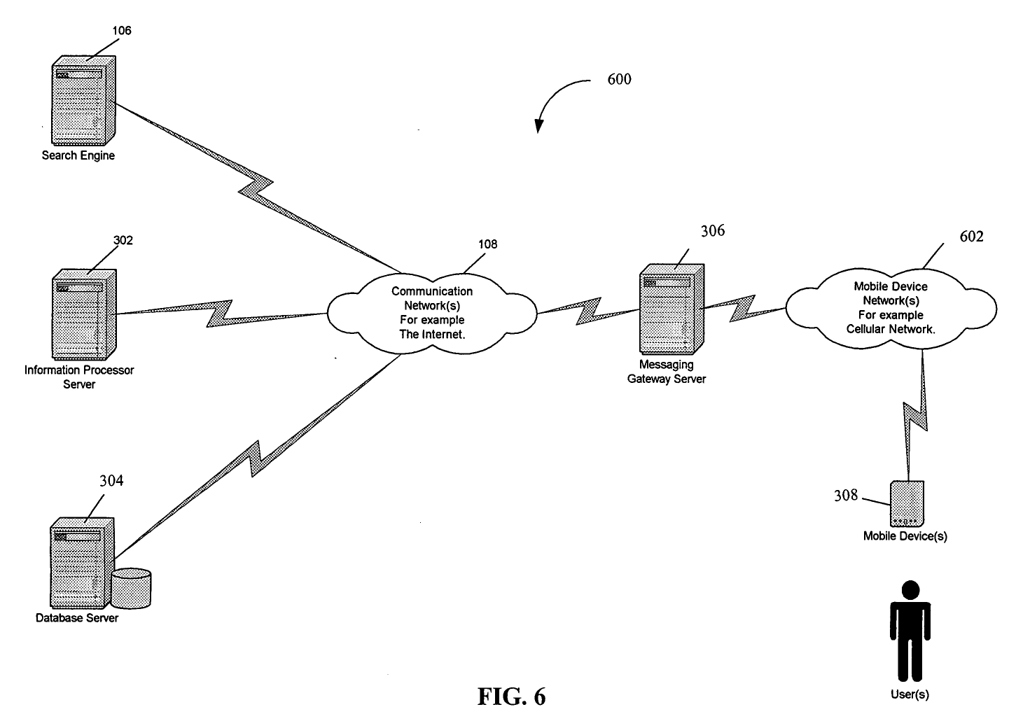

Continuing now with reference to FIG. 6, software residing on an information processor server 302 checks for updates to a user's search engine listings and accounts. Updates can be checked for either by polling the search engine's 106 server directly, or by checking a local database for new changes. If there are changes that the proprietor 202 needs to be notified about, text or multimedia messages are generated and sent to messaging gateway server 306. The messaging gateway server 306 can be set up in multiple ways, but preferably has the ability to take messages from database server 304 and transmit the messages over mobile device network 602 for delivery to a user's mobile device 308, usually by short messaging service (“SMS”), or multimedia messaging service (“MMS”) technologies, as know to those skilled in the art. The messaging gateway server 306 also, preferably, electronically delivers text/multimedia messages received from users back to the information processor server 302.

Preferably, messages received by information processor server 302 from messaging gateway server 306 are compared to an existing command set, and are processed accordingly. Messages that could be processed include messages to modify a user's account on search engine 106, or messages that request more information to be sent to the user in another text/multimedia message.

If the user's account requires changes due to a message, information processor server 302 sends requests to a respective search engine 106 to perform the command requested. Another text/multimedia message can then be sent back to the user via the messaging gateway server 306 confirming success, or alerting the user of any problems that occurred. As noted above, a database representing users' accounts is provided, and preferably maintained, for example, on database server 304.

If a command is received that requests additional information, another text/multimedia message is formulated by information process server 302, and sent to the messaging gateway server 306 for eventual delivery to the user. Messages could include requests for current click-through rates, the amount spent on a particular account, remaining funds balance, or picture graphs of current activity.

All messages received are preferably verified for security by checking the phone number the message was received from, and by using a text/numeric code that is preferably sent with each message. If the security checks are not passed, the received messages will be ignored.

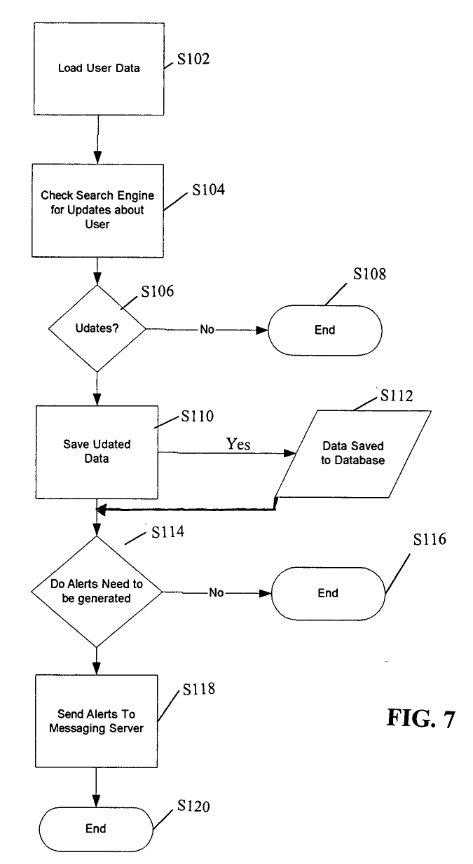

FIG. 7 is a flow chart that illustrates steps associated with an embodiment of the present invention. As shown in FIG. 7, at step S102, user data is loaded into a database maintained on database server 304. Thereafter, information processor server 302 preferably electronically checks search engine 106 for any updated information regarding a web site provided by Internet web site server 102 (step S1104). For example, a bid may have been recently received by search engine 106 which effectively lowers the ranking of a web site provided by Internet web site server 102. At step S1106, a determination is made whether any updates have occurred. If not, then the process ends (step S108). If an update has occurred, then the process branches to step S110 and updated data is preferably saved to the database maintained by database server 304 (steps S1±2, S114).

Continuing with reference to the flowchart shown in FIG. 7, at step S114, another determination is made whether one or more alerts needs to be generated. If not, the process terminates (S116). Otherwise, the process branches to step S118 and one or more alerts are generated and transmitted electronically to message gateway server 306 to be transmitted via mobile device network 602 and delivered to mobile device 308. Thereafter, the process terminates at step S120.

Thus, an alternative embodiment enabling the notification of search engine data via a messaging service platform is further provide by the preset invention.

As will be apparent to one skilled in the art, the present invention provides tremendous improvements over prior art processes related to monitoring and affecting the ranking, placement and appearance of web sites with respect to one or more search engines. Prior art processing steps that were performed by millions of individual computers in order to determine and/or affect the ranking of corresponding web sites by various search engines are substantially reduced by the present invention. The present invention reduces the number of instructions required to be processed and executed by CPU 502, reduces the number of computing devices that execute instructions, and, accordingly, reduces energy consumption, reduces heat production and provides other related technical benefits over prior art systems and methods.

Although the present invention has been described in relation to particular embodiments thereof, many other variations and modifications and other uses will become apparent to those skilled in the art. For example, in an alternative embodiment, proprietor 202 issues a command to proprietor 302 via messaging device 308 in order to affect the position in the search engine ranking. Proprietor 202 may, for example, issue the command without first being alerted on messaging device 308 of a change in positioning.

It is preferred, therefore, that the present invention be limited not by the specific disclosure herein.

What is claimed is:

1. A system for affecting a positing in a search engine ranking of a web site as a function of a messaging device, the system comprising:
an information processor connected to a communication network;
a search engine communication module provided with the information processor enabling a communication session between the information processor and at least one search engine;
a search engine information database accessible to the information processor and adapted to store electronic search engine information received from the at least one search engine regarding a web site; and
a data processing module provided with the information processor operable to process the search engine information from a first format to a second format, and further operable to provide the processed search engine information to the messaging device over the network, and still further operable to receive from the messaging device an instruction and to execute the instruction to affect the position in the search engine ranking of the web site.

2. The system of claim 1, wherein the search engine information relates to at least one selected from the group consisting of organic searching, paid inclusion searching, and bid for placement searching.

3. The system of claim 1, further comprising a monitoring module provided with the information processor for monitoring the web site to verify whether the web site is available over the communication network.

4. The system of claim 3, further comprising an alert module for providing an alert to the messaging device, wherein the alert represents at least one condition as a function of the processed search engine information.

5. The system of claim 4, wherein the condition is at least one of delivery of processed search engine information, an account renewal status update, and a web site uptime status update.

6. The system of claim 1, wherein the information processor checks for updates with the at least one search engine regarding the web site.

7. The system of claim 1, further comprising a messaging gateway server that is operable to receive from the data processing module the processed search engine information and to transmit the processed search engine information to the messaging device.

8. The system of claim 1, wherein the information processor initiates communication with the messaging gateway server.

9. The system of claim 1, further comprising a report module for providing reports by the information processor, wherein the reports regard at least one selected from the group consisting of a web site overview, a keyword position track score, submission to search engines, a paid inclusion status, daily web site uptime, key term search engine listing, number of web site visitors connected via a search engine, number of impressions a key term has received over time, changes in ranking resulting from at least one competing bid, search engine account information, and current bid amounts for key terms.

10. The system of claim 1, wherein the search engine information represents at least one of paid inclusion information, web site ranking information, web site submission information, key term bid information, and account status information.

11. A method for affecting a position in a search engine ranking of a web site as a function of a messaging device, the method comprising:
receiving electronic search engine information by an information processor from a search engine over a communication network, wherein the search engine information regards a web site;
storing the electronic search engine information in a search engine information database accessible to the information processor;
processing the search engine information from a first format to a second format to provide processed search engine information;
providing the processed search engine information to the messaging device over the network;
receiving from the messaging device an instruction in response to the processed search information; and
executing the instruction by the information processor to affect the position in the search engine ranking of the web site.

12. The method of claim 11, wherein the search engine information relates to at least one selected from the group consisting of organic searching, paid inclusion searching, and bid for placement searching.

13. The method of claim 11, wherein the instruction relates to increasing, decreasing a bid or maintaining a bid amount.

14. The method of claim 11, wherein the instruction relates to increasing, decreasing or maintaining the position in the search engine ranking.

15. The method of claim 13, further comprising providing an alert to the messaging device, wherein the alert represents at least one condition as a function of the processed search engine information.

16. The method of claim 15, wherein the condition is at least one of delivery of processed search engine information, an account renewal status update, and a web site uptime status update.

17. The method of claim 11, wherein the processed search engine information is provided to the messaging device via a messaging gateway server.

18. The method of claim 11, further comprising providing reports that regard at least one selected from the group consisting of a web site overview, a keyword position track score, submission to search engines, a paid inclusion status, daily web site uptime, key term search engine listing, number of web site visitors connected via a search engine, number of impressions a key term has received over time, changes in ranking resulting from at least one competing bid, search engine account information, and current bid amounts for key terms.

19. The method of claim 11, wherein the search engine information represents at least one of paid inclusion information, web site ranking information, web site submission information, key term bid information, and account status information.

20. A method for affecting a position in a ranking by a search engine of a web site as a function of a messaging device, the method comprising:
receiving by an information processor from the messaging device an instruction to affect the position in the search engine ranking; and
executing the instruction by the information processor to affect the position in the ranking by the search engine of the web site, wherein the step of executing includes communicating with the search engine and transmitting information to affect the position.
